(19) United States
(12) Patent Application Publication
(10) Pub. No.: US 2026/0208295 A1
(43) Pub. Date: Jul. 23, 2026

(54) LASER PATTERNING INCORPORATING SHEETS

(71) Applicant: NANYANG TECHNOLOGICAL UNIVERSITY, Singapore (SG)

(72) Inventors: Changquan LAI, Singapore (SG); Kang Jueh Dominic Lim, Singapore (SG); Chenhui Cai, Singapore (SG); Jiaxiu Yuan, Singapore (SG); Guo Yao Lim, Singapore (SG); Kai Jie Tai, Singapore (SG)

(21) Appl. No.: 19/157,314

(22) PCT Filed: Jan. 19, 2024
(86) PCT No.: PCT/SG2024/050042

§ 371 Date: Aug. 15, 2025

(30) Foreign Application Priority Data
Feb. 20, 2023 (SG) 10202300437T

(51) Int. Cl. B23K 26/21; B23K 20/12; B23K 26/342; B23K 26/359; B23K 26/38; B33Y 10/00

(52) U.S. Cl. CPC B23K 26/21; B23K 26/342; B23K 26/359; B23K 26/38; B33Y 10/00; B23K 20/1205

(57) ABSTRACT

An apparatus includes a laser, a clamp, and a workpiece positioner. The laser is operable as a pulsed laser to cut a sheet. The clamp is displaceable relative to a working zone of the apparatus. The workpiece positioner is configured to support a workpiece in the working zone with the workpiece. In a bonding stage, the clamp and the workpiece positioner are operable to cooperatively push the sheet and the workpiece toward one another, and a selective bonding of the sheet with the workpiece is formed in the bonding stage. In a cutting stage, the clamp is displaceable away relative to the working zone to enable the laser to cut the sheet along a perimeter of the selective bonding.

### RELATED APPLICATION

This application claims the benefit of priority to the Singapore application no. 10202300437T filed Feb. 20, 2023, the contents of which are hereby incorporated by reference in their entirety for all purposes.

### TECHNICAL FIELD

The present disclosure relates to laser-based manufacturing methods and apparatus, and to products made thereby.

### BACKGROUND

Making components lighter in weight, or lightweighting, is one important way for sustainable use of energy. Lightweighting is a challenge. This is particularly the case in applications where strength and safety are critical requirements. The original materials selection, shape, and dimensions were selected to meet safety requirements. For example, the lightweight replacement for many components in an aircraft, automobile, building, etc., must be as strong as the original traditionally fabricated component. The variety of materials with the necessary strength-to-weight ratio is limited. Using a lighter material may not satisfy the strength and safety requirements. An alternative is to consider the use of hollow structures (such as a honeycomb structure) to replace solid structures. Hollow structures are traditionally more challenging to fabricate. The mass production of such hollow structures is an additional technical challenge.

### SUMMARY

In one aspect, the present application discloses an apparatus, the apparatus including: a laser, a clamp, and a workpiece positioner. The laser is operable as a pulsed laser to cut a sheet. The clamp is displaceable relative to a working zone of the apparatus. The workpiece positioner is configured to support a workpiece in the working zone with the workpiece. In a bonding stage, the clamp and the workpiece positioner are operable to cooperatively push the sheet and the workpiece toward one another, and a selective bonding of the sheet with the workpiece is formed in the bonding stage. In a cutting stage, the clamp is displaceable away relative to the working zone to enable the laser to cut the sheet along a perimeter of the selective bonding.

In another aspect, the present application discloses a method including: in a bonding stage, cooperatively pushing a sheet and a first surface of a workpiece together between a clamp and a workpiece positioner simultaneously with a forming of a selective bonding of the sheet with the workpiece; displacing the clamp away relative to the working zone; and in a cutting stage, laser cutting along a perimeter of the selective bonding.

In yet another aspect, the present application discloses an article in which the article includes an array of cells, each of the cells including at least one cell wall defining an interior space, and in which the at least one cell wall includes a plurality of layers joined together using any embodiment of the method described above.

### BRIEF DESCRIPTION OF THE DRAWINGS

FIG. 1A to FIG. 1G schematically illustrate a method of manufacturing, according to some embodiments of the present disclosure;

FIG. 2A to FIG. 2G schematically illustrate the method according to other embodiments of the present disclosure;

FIG. 3A to FIG. 3E schematically illustrate the method according to yet other embodiments of the present disclosure;

FIG. 3F is a schematic drawing of a top view of an article made according to the method of FIG. 3A to FIG. 3E;

FIG. 4A is a top view of a clamping plate;

FIG. 4B is a perspective view of an apparatus according to various embodiments of the present disclosure;

FIG. 4C is a magnified perspective view of a part of FIG. 4B;

FIG. 5A is a perspective view of an apparatus according to various embodiments of the present disclosure;

FIG. 5B is a magnified perspective view of a part of FIG. 5A;

FIG. 6A to FIG. 6C are schematic drawings of the apparatus at various steps of the method according to some embodiments of the present disclosure;

FIG. 7 is a schematic drawing of a part of the apparatus according to another embodiment;

FIG. 8 is a schematic drawing of a part of the apparatus according to yet another embodiment;

FIG. 9 is a schematic drawing of a part of the apparatus according to another embodiment;

FIG. 10 is a schematic drawing of a part of the apparatus according to another embodiment;

FIG. 11 is a schematic drawing of a part of the apparatus according to yet another embodiment;

FIG. 12 is a schematic drawing showing the bonding stage according to an alternative embodiment of the present disclosure;

FIG. 13 is a schematic drawing showing the bonding stage according to another embodiment;

FIG. 14 is a schematic drawing showing an example of rotary friction welding;

FIG. 15 is a schematic drawing showing an example of a translational friction welding;

FIG. 16 and FIG. 17 are perspective views of articles that can be made using the apparatus;

FIG. 18A and FIG. 18B show a perspective view and a top view of an article made using the apparatus; and

FIGS. 19A to 19E are images of articles made using the apparatus; and

FIG. 20 shows images of specimens used in tensile strength tests.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

The term “and/or” includes any and all combinations of one or more of the associated listed items.

The terms “about” and “approximately” as applied to a stated numeric value encompasses the exact value and a reasonable variance and the terms “generally” and “substantially” are to be understood in a comparable manner, unless otherwise specified. For example, in the context of various embodiments, the term “about” or “approximately” as applied to a stated numeric value will be generally understood by one skilled in the art to encompass the exact value and a reasonable variance as generally understood in the relevant technical field, e.g., within 10% of the specified value.

The word “exemplary” is used herein to mean “serving as an example, instance, or illustration.” Any embodiment described herein as “exemplary” is not necessarily to be construed as preferred or advantageous over other embodiments. As used herein, the singular “a”, “an”, and “the” may be construed as including the plural “one or more” unless apparent from the context to be otherwise.

Terms such as “first” and “second” are used in the description and claims only for the sake of brevity and clarity, and do not necessarily imply a priority or order, unless required by the context.

Some methods may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

Three-dimensional (3D) arrays of repeated units or cells may collectively form a larger article with one or more hollow interior spaces such that the article is comparatively lighter in weight than an entirely solid article of similar size. Natural examples of such 3D arrays include the honeycomb. Each unit of a 3D array may be described as a closed cell or a partially-closed cell. For the sake of brevity, as used herein and unless otherwise specified, the term “cell” refers to any type of cell in a 3D array, including but not limited to a closed cell and a partially closed cell. Similarly, the terms “cells” may refer to a plurality of any one or combination of closed cells and/or partially closed cells.

As used herein, the terms “closed cell” or “isolated pore” may refer to a unit with a wall or walls completely enclosing an interior space (isolated space), in which the interior space is not in fluid communication with the exterior of the unit. The interior spaces of two immediately adjacent closed cells are not in fluid communication with one another.

As used herein, the term “partially closed cell” refers to a unit with one or more struts and/or walls partially defining an interior space, in which the interior space is in fluid communication with the exterior of the unit. For example, a partially closed cell may be described as having a cell having openings in its wall. For example, the interior spaces of two immediately adjacent partially closed cells may be in fluid communication with one another and/or with the interior spaces of other partially closed cells. In some cases, a plurality of partially closed cells may define one or more complex channels.

Arrays of cells, such as honeycomb-like structures, are useful in a wide range of applications. Using conventional methods, arrays of cells can be difficult to manufacture to the required strength. For example, the conventional additive manufacturing method of extrusion can build up a cell by extruding a viscous extrudate and depositing it on a previously deposited layer of material. The deposited layers are then cured (e.g., polymeric extrudate) or sintered (e.g., ceramic or metallic extrudate) to solidify the extrudate. The sintered cell typically does not have the strength required for high-performance engineering applications such as aerospace parts or the durability required for applications in harsh environments.

Another conventional method that may be used to build up a structure in layers is sheet lamination. The strength of the finished article is dependent on the strength of adhesion and/or bonding between the layers. For example, the tensile yield strength achievable using conventional laser foil printing of 304 stainless steel is reportedly around 632 MPa (megapascals) which may not meet the requirements of some high-performance engineering applications.

In various techniques theoretically capable of making a closed cell, there is an additional difficulty in ensuring that the interior space is free of any powder or cut-out parts. 3D arrays of cells and complex channels are especially difficult to mass manufacture in a continuous or fully automated process. Some methods would inevitably result in the precursor materials being trapped in the interior spaces of cells or complex channels. Even in the case of a partially closed cell or complex channel, it would be difficult to completely remove such trapped materials from a 3D array of partially closed cells, even if the production is interrupted to manually remove material trapped in the cells.

Embodiments of the present method and apparatus will be described to illustrate the ability to form various shapes and sizes of cells, in which technical issues faced by conventional methods are addressed.

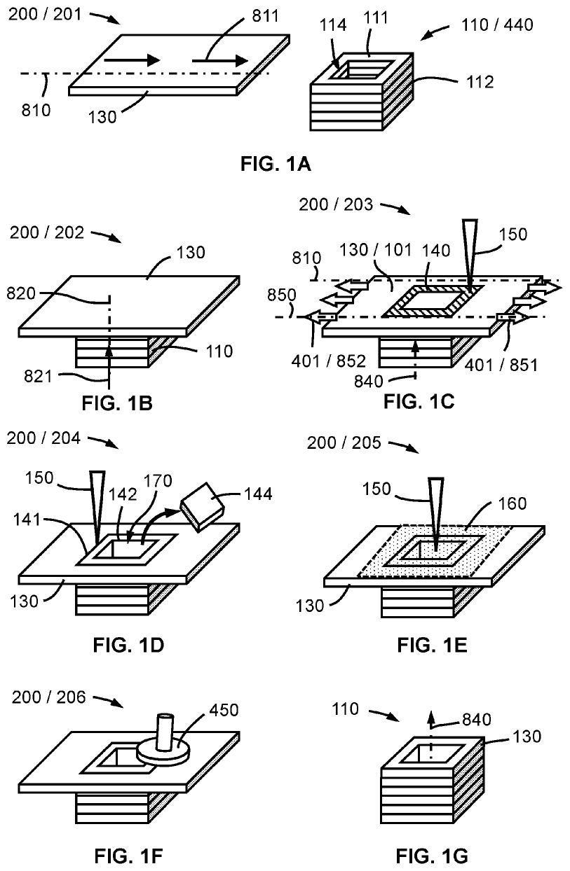

FIG. 1A to FIG. 1G schematically illustrate various steps in a method or process 200 of manufacturing, in accordance with embodiments of the present disclosure.

FIG. 1A shows a step 201 of setting up in which a partially formed workpiece 110 is provided in a working zone 440. A sheet 130 in the form of a solid sheet is provided in a feed direction 811 (e.g., also interchangeably referred to as being displaced along a first axis 401 810) in the working zone 440. For the sake of clarity, the sheet 130 is illustrated as a discrete planar part although the sheet 130 may be a part of a continuous roll of material. To illustrate, the workpiece 110 is shown with a wall 112 defining an open cavity 170. The workpiece 110 may be built using additive manufacturing techniques, including the present method 100.

FIG. 1B shows a step 202 of aligning the sheet 130 with a first surface 111 of the workpiece, for example, with a solid sheet or sheet 130 aligned with the open cavity 170 of the workpiece 110. The workpiece 110 may be pushed in a push direction 821 (along a second axis 820) toward the sheet 130.

FIG. 1C shows a step 203 of bonding (bonding stage). In this example, the bonding stage includes laser welding in which the sheet 130 is laser welded when under tension. For example, the sheet 130 may be stretched or tensioned by opposing tensioning directions 851/852 (e.g., along a tension axis 850) so that the sheet 130 is flat or substantially flat, to minimize or reduce creasing or warpage. The tension axis 850 and the feed axis 810 may be parallel and coincidental with a reference plane 101 in which the sheet 130 is disposed. Optionally, the tension axis 850 and the feed axis may be both disposed in the reference plane 101 and non-parallel to one another. During the bonding stage, the sheet 130 in the working zone is at least partially clamped between the workpiece positioner 500 and a clamp 600.

The apparatus is configured to switch from a bonding configuration to a cutting configuration as the process 200 transitions from the bonding stage to the cutting stage. The transition may include displacing at least a part of the clamp 600 away from the working zone 440.

For convenient reference, the area where the sheet 130 is in physical contact with the first surface 111 of the workpiece 110 is referred to as a selected area 140. A pulsed laser 150 is directed to scan within the selected area 140 (e.g., where the sheet 130 overlaps the first surface 111 of the workpiece 110) so that the sheet 130 is joined or bonded (e.g., by laser welding) to the workpiece 110 in one or more continuous sections within the selected area 140. The laser parameters of the pulsed laser 150 may be selected to enable laser welding of the sheet 130 to the first surface 111 of the workpiece 110. A commercially available laser source may be used. The laser 150 may be configured to direct a pulsed laser opposite a build direction 840, with the workpiece 110 being built up the build direction 840 by the addition of the sheet 130.

FIG. 1D shows a step 204 of laser cutting in which the same pulsed laser 150 is directed to scan along the perimeters 141, 142 of the selected area 140. The laser parameters may be selected to enable laser cutting. For example, the same pulsed laser 150 used in laser welding (FIG. 1C) is used in laser cutting along each of an outer perimeter 141 and an inner perimeter 142 of the selected area 140. A cut-out 144 of the sheet 130 is formed by the laser cutting along the inner perimeter 142. The cut-out 144 of material is observed to eject itself out of the sheet 130, as illustrated in FIG. 1D. The sheet 130 now defines a through hole that is now a part of the cavity 170 of the workpiece 110. The cut-out 144 of material does not drop into the cavity 170 of the workpiece 110. Alternatively, depending on the laser parameters and the material of the layers/workpiece, the cut-out 144 may be burnt and/or vaporized such that no part of the cut-out 144 remains or drops into the cavity 170.

If the sheet 130 is a metal, the same pulsed laser may be used to remove any oxides from the layer of material in a step 205 of cleaning, as illustrated in FIG. 1E. The step 250 of cleaning may include using the same pulsed laser 150 to perform surface remelting to reduce defects on the surface. The cleaning may be performed over a treated area 160 (as illustrated in dotted/dashed line) larger than the selected area.

Debris and burrs (e.g., resulting from the laser cutting of FIG. 1D) may be removed by mechanical grinding or mechanical polishing in a step 206 of polishing. For example, the apparatus 400 may include a polishing device that includes a sandpaper rotatable by a polishing motor 450.

FIG. 1G shows the resulting workpiece with one more layers built up in the build direction 840. That is, the sheet 130 is now a part of the workpiece 110. The layers of material form a part of a wall around a cavity.

To form a closed cell, a new layer of material may be laser welded to the new topmost surface of the workpiece, in which there are no through holes in the new layer of material. For example, to form a closed cell, in the step of laser welding, laser welding is performed along the selected area 140 without performing laser cutting along the inner perimeter 142 of the selected area 140. The ability to form and stack through holes without the need to stop the process and remove cut-outs and/or powder from the cavity enables a continuous process of forming multiple cells. The method and apparatus proposed herein can be further applied to form 3D arrays of cells with complex configurations.

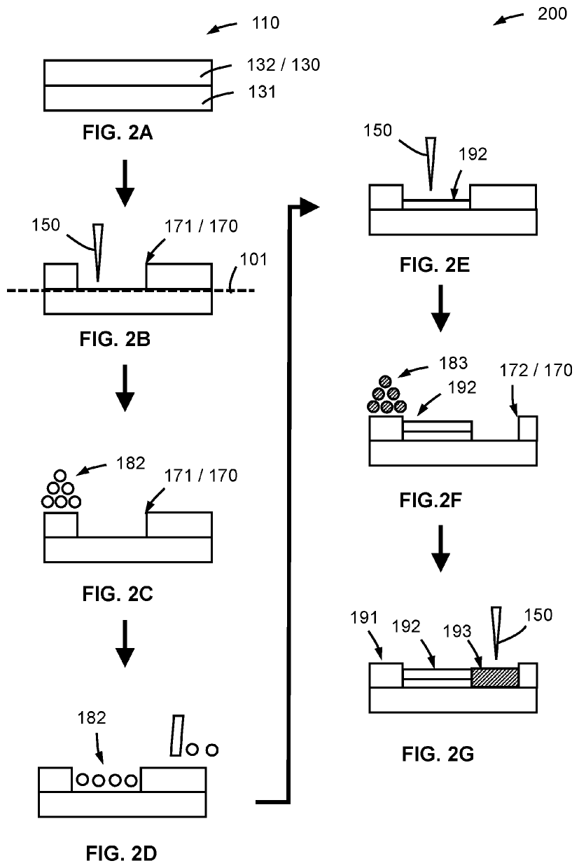

FIGS. 2A to 2G schematically illustrate another embodiment of the present method 200. FIG. 2A and FIG. 2B show a workpiece 110 formed by a first layer 131 of a first material joined to a second layer 130 of the first material. A cavity 170 may be formed in the workpiece 110 as described above.

For example, the second layer 132 of the first material (e.g., a sheet 130) may be aligned relative to the first layer 131 of the first material. The first layer 131 and the second layer 132 are pushed or pressed toward one another. In this example, there is no cavity in the first layer of the first material. The second layer 132 of the first material may be placed under tension forces along opposing directions parallel to a reference plane 101 defined by the first layer 301 of the first material. A pulsed laser 150 may be used to weld one or more sections of the second layer 132 to the first layer 131. For example, the pulsed laser 150 may weld two parallel and spaced apart lines that are orthogonal or substantially orthogonal to the directions of the tension forces. The pulsed laser 150 may then be used to cut along a perimeter of a selected area such that a cut-out piece is formed. The cut-out piece would be observed to pop out of the second layer 132 of the first material.

After a cavity 170 is formed in the second layer 132 (also referred to as a first cavity 171 for the sake of clarity), an amount of powder 182 of a second material may be deposited in the first cavity 171, as illustrated in FIG. 2C and FIG. 2D. Excess powder may be scraped away, as illustrated in FIG. 2D. FIG. 2E shows the pulsed laser 150 performing laser sintering of the powder 182 of the second material. Additional layers 192 of the second material may be built up by adding more powder of the second material and performing laser sintering of the added powder, as shown in FIG. 2F. The first cavity 171 serves as a template to define the shape and dimensions of the part made of the second material.

FIG. 2F also shows that a second cavity may be formed. In this example, the second cavity is immediately adjacent to both the first material and the second material. For example, the second cavity may be partially defined by the first material and partially defined by the second material.

An amount of powder of a third material may be added to the second cavity and laser sintered, as shown in FIG. 2F and FIG. 2G.

The resulting article may be an integral solid of multiple materials.

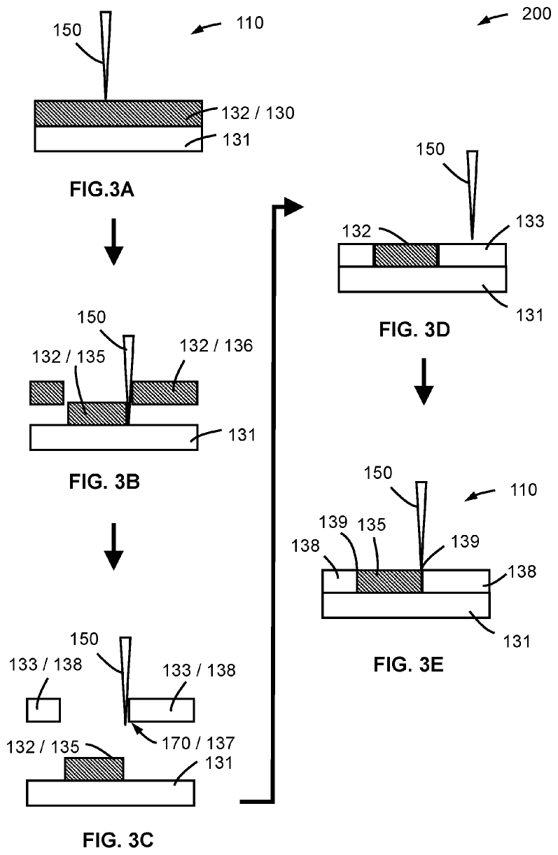

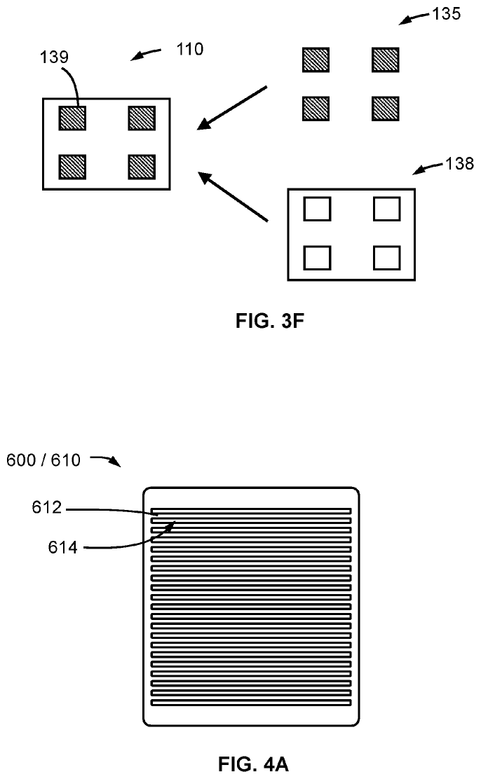

FIG. 3A to FIG. 3E shows another embodiment of the present method 200. In this example, a first layer 131 of a first material is provided. As shown in FIG. 3A, a second layer 132 of a second material is aligned relative to the first layer of the first material. The first layer 131 and the second layer 132 are pushed or pressed toward one another, and selectively bonded to one another. For example, the selective bonding may include welding a selected area of the second layer 132 to the first layer by pulsed laser 150 (the same pulsed laser 150 used for laser welding). The pulsed laser 150 is then used to cut along a perimeter of the selected area, to enable separation of the welded area of the second later 132 from the unwelded area 136 of the second layer 132. The unwelded area 136 of the second layer 136 can then be displaced apart from the first layer 131. An “isolated pattern” 135 or an “island” of the second layer (and in this case, the second material) is formed, in which the isolated pattern 135 is welded to the first layer 131 (FIG. 3B). The sides of the isolated pattern may be cleaned and/or deburred using the pulsed laser 150.

FIG. 3C shows a step in which the pulsed laser 150 is used to cut a cavity 137 in a third layer 133 of the third material. The third layer 133 may also be described as a layer with at least one cavity 137 defining a connected pattern 138. The connected pattern 138 (in this example, the cavity 137) may be configured to mate in a complementary manner with the profile or the shape of the isolated pattern 135. After the requisite one or more cavity 137 is formed in the third layer 133, the connected pattern 138 is transported into alignment with the rest of the corresponding one or more isolated pattern 135, e.g., the cavity 137 of the third layer 133 may be aligned with the isolated pattern 135 of the second layer 132.

In various embodiments of the method 200, the one or more isolated patterns 135 are formed before the corresponding one or more connected patterns 138 are formed.

As shown in FIG. 3D, the connected pattern 138 (e.g., the cavity 137) and the isolated pattern 135 may be mated together. The pulsed laser 150 is used to weld the third layer 133 (e.g., one or more selected area) to the first layer 131. FIG. 3D shows the interface 139 between the through hole of the third layer 133 and the isolated pattern 135 of the second later 132.

FIG. 3E shows the interface 139 between the first material and the second material being welded using the same pulsed laser 150. That is, the outer perimeter of the isolated pattern 135 may be welded to the connected pattern 138 at the interface 139.

The result is a heterogenous article or workpiece 110. The method 200 may be repeated to obtain various configurations of multimaterial articles. The method 200 may be varied in terms of the depth of cutting, e.g., the cutting of the isolated pattern and/or the connected pattern need not be a cut through the entire thickness of the sheet. For example, the cutting may be performed through the entire thickness of a sheet of material (e.g., a through cut as described in the example above) or the cutting may be through less than the full thickness of the material (e.g., similar to engraving).

In some embodiments, various embodiments of the method 200 may be implemented to form 3D arrays of cells in which different cells are formed of a different material. In some embodiments, various embodiments of the method 200 may be implemented to form 3D arrays of cells in which at least one cell is formed of multiple materials.

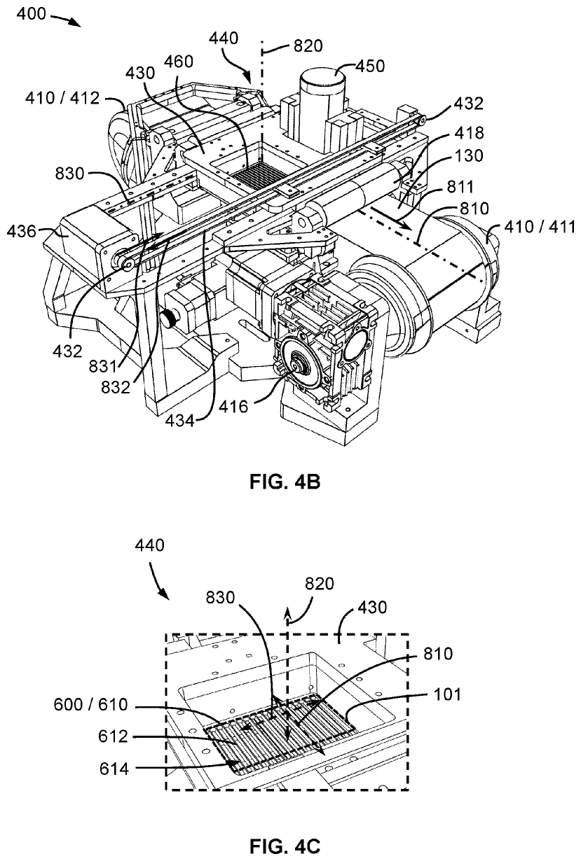

FIG. 4A is an example of a clamp 600 that may be used in facilitating or enabling the biasing of the workpiece and the sheet toward one another. In this example, the clamp 600 may include a clamping plate 610. The clamping plate 610 may include a plurality of bar clamps 612. The bar clamps 612 may be spaced apart to define a plurality of elongated openings 614. The clamping plate 610 may be in the form of a grating as shown in FIG. 4A or other more porous patterns (e.g., for more complex geometries to be welded in a first pass of the laser). In some other embodiments, the clamping plate 610 may be a plate that is transparent to the laser without providing physical through holes in the plate.

FIG. 4B is a perspective view of a prototype of an apparatus 400 with the clamping plate 610 of FIG. 4A. The clamping plate 610 may be alternately displaced into and out of the working zone 440. FIG. 4C is a magnified view of the working zone 440 of the apparatus of FIG. 4B with the clamping plate 610 disposed at the working zone 440.

The apparatus 400 includes a sheet holder, such as a sheet feeder 410. Embodiments of the sheet feeder 410 may include but are not limited to a roll-to-roll set-up, a set of roller drums, etc. The sheet feeder 410 is oriented to dispense or provide a sheet-like material, a layer of the material, or a sheet 130 of material to a working zone 440. For the sake of brevity, the terms “sheet” and “layer” may be used interchangeably in the present disclosure. For example, the sheet feeder 410 may include a second roller drum 412 configured to provide a discrete sheet 130 or a continuous sheet 130. The sheet feeder 410 may include a first roller drum 411 to collect the sheet 130. The first roller drum 411 may be operable by a first motor 416 to draw a continuous sheet 130 across the working zone 440. The sheet 130 may be displaced across a working zone 440, between the roller drums of the sheet feeder 410, in a feed direction 811, along a first axis 810 in a reference plane 101. Optionally, the sheet 130 may be passed via additional pairs of rollers 418 to aid in keeping the sheet 130 flat. For the sake of brevity, references to a sheet or a layer of material being flat will be understood to include the sheet or the layer of material being substantially flat and/or totally flat.

Further details of the apparatus 400, which may not be apparent in the view of FIG. 4B but which will be described in the following with reference to other figures, may include a workpiece positioner displaceable along a second axis 820, in which the second axis 820 is orthogonal to the first axis 810. The second axis 820 may be defined to be parallel to the build direction 840.

The apparatus 400 includes a clamp 600 with a clamping plate 610 supported in the reference plane 101 by a gratings support 430. In this example, the gratings support 430 (and hence the clamping plate 610) may be displaced back and forth along a third axis 830 in the reference plane 101. For example, the clamping plate 610 may be displaced in a third direction 831 toward the working zone 440 for the bonding stage. For example, the clamping plate 610 may be displaced in a fourth direction 832, opposite to the third direction 831 and away from the working zone 440. In some embodiments, the third axis 830 and the first axis 810 may be coplanar and orthogonal to one another, as illustrated in FIG. 4B. Alternatively, in some other embodiments, the third axis 830 and the first axis 810 may be coplanar and parallel to one another. In yet other embodiments, the third axis 830 and the first axis 810 may be coplanar and with an angular displacement relative to one another. The clamping plate 610 may be displaced by a second motor 436. The gratings support 430 may be attached to a belt 434 and pulley 432 so that operation of the second motor 436 displaces the gratings support 430 and the clamping plate 610. For example, the second motor 436 may include a stepper motor configured to displace the gratings support 430 into and out of the working zone 440, along the third axis 830.

The clamping plate 610 may be disposed parallel to a reference plane 101. The clamping plate 610 may be displaceable parallel to the reference plane 101, e.g., along the first axis 810 and/or the third axis 830. The second axis 820 may be defined as a normal axis to the reference plane 101 or the build direction. When clamping plate 610 is in the working zone 440, the pulsed laser 150 may scan along scan paths defined by the elongated openings 614 of the clamping plate 610. For example, the pulsed laser 150 may scan along lengths of scan paths parallel to any one of the reference plane 101, the first axis 810, and the third axis 830.

The apparatus 400 may be used to perform any one or a combination of the methods described above with reference to FIGS. 1A to 3E. For example, the sheet feeder 410 may be operable to feed a sheet 130 of a first material along the first axis 810 to dispose the sheet 130 in parallel to the reference plane 101 in the working zone 440 of the apparatus 400.

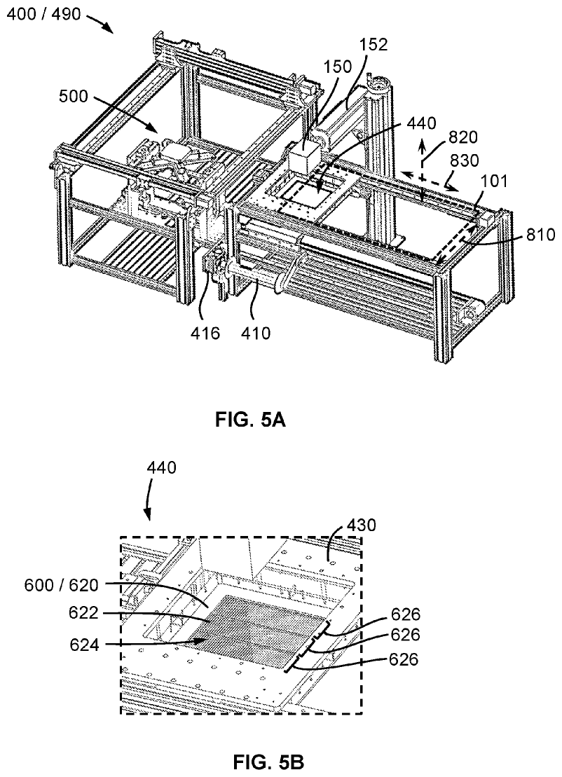

The workpiece positioner 500 may be configured to support the workpiece such that the workpiece positioner 500 (or the workpiece 110) is displaceable along the second axis 820 to abut the first surface 111 of the workpiece 110 against the sheet 130 in the working zone 440. The second axis 820 may be defined to be normal to the reference plane 101 or parallel to the build direction 840. It was found that the pressing or clamping directions 821/822 along the second axis need not be “upwards”/“downwards” or “vertical” with respect to the ground. Prototypes have been built and verified to be operable with the push direction 821 in various directions including but not limited to “sideways” directions. Similarly, it will be understood that the reference plane 101 need not be “horizontal” with respect to the ground as shown in FIG. 4B and FIG. 5A.

The clamp 600 and the workpiece positioner 500 (or the workpiece 110) can cooperatively flatten the sheet 130 between the clamp 600 and the first surface 111 of the workpiece 110. The clamp 600 may be configured to define at least one elongated opening 614 in the reference plane 101 such that the laser 150 may be configured to irradiate the sheet 130 through the at least one elongated opening 614. The laser 150 is configured to scan or to be operable along a scan path defined by the at least one elongated opening 614. The laser 150 is a pulsed laser that is alternately operable to join (bond) the sheet 130 (e.g., by heating or by laser welding) with the workpiece 110 and to cut through the sheet 130. That is, one pulsed laser 150 suffices to perform all the laser-related operations for the apparatus 400.

The bonding stage is preferably performed with a first bonding or a first joint occurring in a continuous bonded length rather than in spots. In the examples where the bonding stage includes laser welding, the laser 150 is operable to form a first joint between the sheet 130 and the workpiece 110 such that the first joint is a continuous welded length parallel to the reference plane 101. This is in contrast to spot welding. Without being bound by theory, the formation of continuous welded lengths between the sheet 130 and the workpiece 110 in a single pass of the laser (without prior spot welding between the sheet 130 and the workpiece 110) is observed to produce articles of surprisingly better quality in terms of flatness of the layers and the tensile strength of the article. That is, as used herein, the term “first joint” refers to a joint formed between a sheet 130 and a first surface 111 of a workpiece 110 that are not otherwise or previously welded.

FIG. 5A shows another prototype of the apparatus 400 used in making a multi-material article or workpiece, such as that of FIG. 2G or FIG. 3E. In this example, the apparatus 400 includes a gantry system 490 to enable relative movement of the laser 150, the working zone 440 110, etc. Similar to the example of FIG. 4A, the apparatus 400 enables displacement of a new layer of material along a first axis 810 relative to the working zone 440, in a feed direction 811. For example, a first motor 416 and sheet feeder 410 may be provided to extend and displace a layer of material along the first axis 810. Similar to the example of FIG. 4A, the gantry system 490 of FIG. 5A enables displacement of the clamp 600. In this example, the clamp 600 includes a clamping plate 620 supported by the gratings support 430. The clamping plate 620 may be displaced along a third axis 830 that is orthogonal to the first axis 810. The apparatus 400 includes a pulsed laser 150 supported by an actuator 152 such that the pulsed laser 150 may be positioned in various locations relative to the working zone 440. The apparatus 400 includes a workpiece positioner 500 that can be positioned in various locations relative to the working zone 440 and/or the pulsed laser 150. For example, the gantry system 490 may be configured with a motor-operable pulley-and-belt system or a motor-operable slide-and-rail system such that the workpiece positioner 500 can be displaced along the first axis 810 and/or the third axis 830. The workpiece positioner 500 may be configured to be displaceable along the second axis 820, in which the second axis 820 is orthogonal to the first axis 810 and the third axis 830. For example, the second axis 820 may be coincidental with the build direction 840. For example, the second axis 820 may be parallel to a vertical direction relative to one or more horizontally disposed layers 130 of material supported by the workpiece positioner 500.

FIG. 5B is a magnified view of the clamping plate 620 of FIG. 5A, showing a variation of the elongated openings 624. For example, the clamping plate 620 may include more than one row 626 of elongated openings 624, in which each elongated opening is defined by spaced apart clamp bars 622.

In some embodiments, the apparatus 400 may be configured with an automatic material feeder (also referred to as a workpiece positioner 500) to enable more efficient and automated building up of the multiple layers required to form 3D arrays of cells. The workpiece positioner 500 may cooperate with the clamp 600 to clamp on to the sheet 130 in the working zone 440. For example, the workpiece positioner 500 may support the workpiece 110 such that, in cooperation with the clamp 600, a part of the layer 130 is held stationary in a flat or substantially flat shape to receive pulsed radiation from the laser 150.

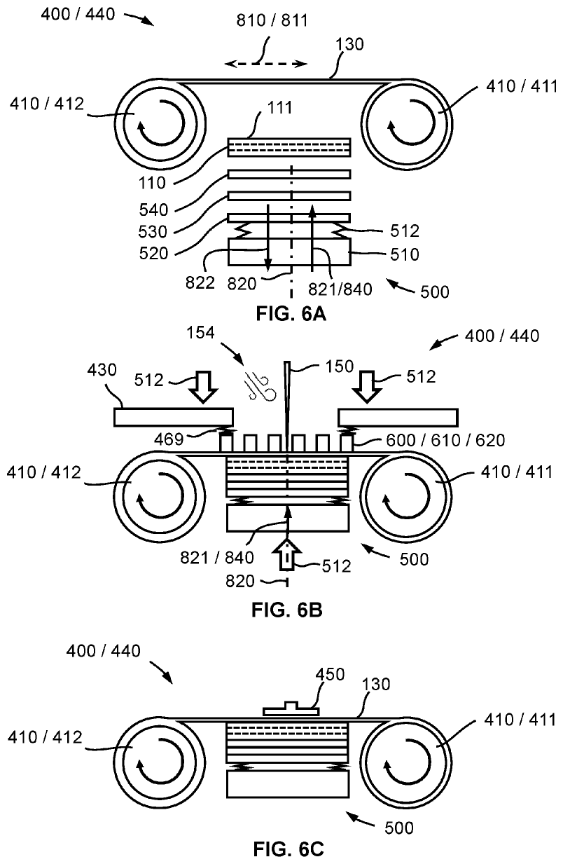

FIG. 6A is a figure illustrating a part of the apparatus 400 in the vicinity of the working zone 440. The roller drums of a sheet feeder 410 may be provided on opposing sides of the working zone 440, and may be cooperatively rotatable to extend a sheet 130 in the working zone 440. In the example illustrated, the sheet 130 may be displaced along the first axis 810 (e.g., in a feed direction 811 from left to right of the figure, or in a feed direction 811 from right to left of the figure). In some embodiments, the sheet feeder 410 may be configured to displace a sheet in any of two opposing directions 811/812 along the first axis 810, e.g., to re-position the sheet 130 relative to workpiece 110. The sheet feeder 410 may be locked or prevented from rotation upon tensioning or stretching the layer 130 relatively flat. The tension axis 850 may be parallel to the first axis 810 or angularly displaced relative to the first axis 810. In some examples, the tension axis 850 may be parallel to the third axis 830 (into/out of the paper).

The workpiece positioner 500 is illustrated as an assembly exploded along the second axis 820 to better show the various parts. The workpiece positioner 500 may include a positioning actuator 510. In some embodiments, the positioning actuator 510 may be displaceable along the second axis 820 (e.g., closer to the layer 130 or further from the sheet 130). Before the bonding stage, the positioning actuator 510 may be displaced in the build direction 840 or in the push direction 821. When the clamp 600 is unclamped, e.g., to permit displacement of the sheet 130, the positioning actuator 510 may be displaced in a direction 822 opposite to the build direction 840 or opposite to the push direction 821. The positioning actuator 510 may be motor driven, pneumatically driven, manually operable, etc.

The workpiece positioner 500 may include a heater/cooler 530 to controllably adjust the temperature of the workpiece 110. The workpiece positioner 500 may include a base plate 540 to which a workpiece 110 may be releasably secured. The base plate 540 may be heated by the heater/cooler 530 to reduce residual stresses. Alternatively, the base plate 540 may be cooled by the heater/cooler 530 to increase the cooling rate and bring about certain desired microstructures in the material. One or more (compressive) force sensors 520 may be coupled beneath the base plate 540.

The laser welding is performed with the pulsed laser 150 scanning sections of the layer 130 along the elongated openings of the clamping plate 610/620. FIG. 6B shows the laser welding of FIG. 1C being performed with the sheet 130 clamped between the clamping plate 460 and the first surface 111 of the workpiece 110. Clamping forces 512 directed along the second axis 820 may be controllably adjusted in response to feedback from the one or more force sensors 520 disposed on the workpiece positioner 500. The clamping force 512 (in the push direction 821) on the sheet 130 is controllably variable in response to feedback signals from the force sensor 520.

A blower or a suction 154 may be provided to cool the layer 130 during laser welding and/or laser cutting. The blower or suction 154 may also aid in the removal of material during cutting. Although the cutout piece was observed to pop out of the layer 130, other methods may alternatively be used to remove unwanted material from the workpiece, e.g., using a vacuum, fan, magnet, brush, tape, gravity (e.g., rotating the entire setup upside down permanently), etc. Alternatively, the unwanted areas may be cut from the layer 130 and left on the base plate 540 to provide support for the next layer of material. Springs 512, 469 may be provided to provide some tolerance for the parts and to provide an elastic bias to the clamping of the layer 130.

In the polishing step (FIG. 6C), the laser 150 and the clamping plate 610/620 may be displaced away from the working zone 440 (e.g., in the direction 822 opposite to the push direction 821). The polishing device 450 may be applied to deburr and polished the surfaces in readiness for the workpiece 110 to receive another sheet 130.

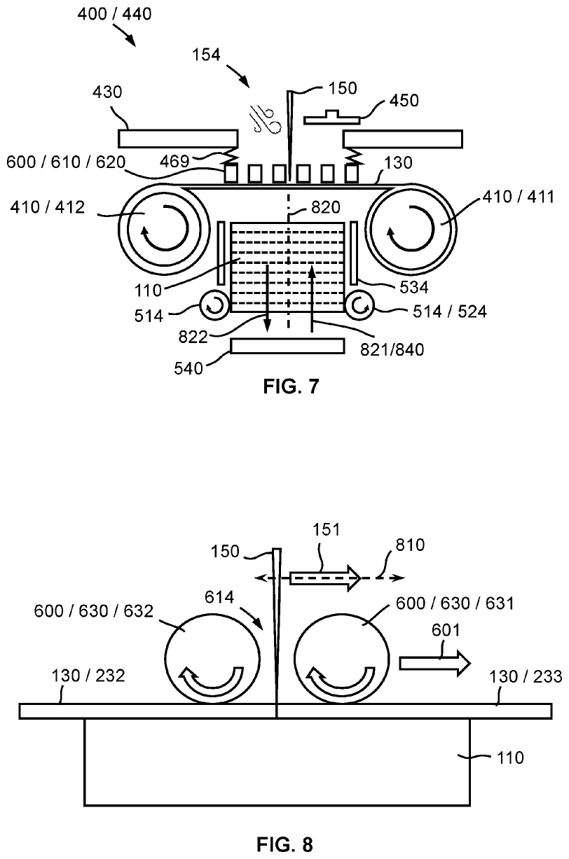

FIG. 7 is a schematic diagram showing a part of another embodiment of the apparatus 400. The workpiece 110 may initially be supported by a base plate 540 that can be displaced along the second axis 820 (e.g., displaced in the build direction 840/displaced in a direction 822 opposite to the build direction 840) as the number of layers (or the thickness) of the workpiece 110 increases. The positioning actuator 510 in this example takes the form of at least one pair of positioning rollers 514 on opposing sides of the workpiece 110. When the workpiece 110 is sufficiently thick such that the sides of the workpiece 110 can slidingly engage the positioning rollers 514, the base plate 540 becomes optional. At least one shear force sensor 524 may be provided at the positioning roller 514 to provide feedback on the position of the workpiece 110. A heater or cooler 534 may be provided at opposing sides of the workpiece 110 to serve as a guide for the workpiece as well as to adjust the temperature of the workpiece 110.

In the bonding stage (e.g., during laser welding), the positioning rollers 514 may support the workpiece 110 in a position where the workpiece 110 is pushed against the clamping plate 610/620. When the workpiece 110 is ready to have another layer 130 added to it, the positioning rollers 514 may rotate in opposing directions (one clockwise and another anticlockwise) to lower the workpiece 110 (to accommodate a new layer of material). This configuration advantageously and theoretically enable an unlimited build height to the workpiece 110. That is, the apparatus 400 does not place a limit on the number of layers added to the workpiece 110.

The laser parameters of the pulsed laser 150 are controllably variable in response to the type of materials selected for the sheet 130. For example, the laser power, scanning speed, and/or pulse frequency of the pulsed laser 150 are selected to enable joining of the sheet 130 to the first surface of the workpiece 110. The laser welding can be further improved through the subsequent use of a heater 534 (e.g., radiative heater, hot air gun etc.) or a lamp that directs heat and/or radiation to the workpiece 110.

FIG. 8 is a schematic drawing of a part of the apparatus 400 according to another embodiment of the present disclosure. In place of the clamping plate 610/620, the clamp 600 includes a set of roller clamps 630. The pulsed laser 150 is positioned between the first roller clamp 631 and the second roller clamp 632. The new sheet 130 (yet to be welded region 233) is disposed between the workpiece 110 and the roller clamps 630.

In this example, during the bonding stage or the step 203 of bonding (e.g., FIG. 1C, FIG. 3D, etc.), the first roller clamp 631 and the second roller clamp 632 are rotated in the same direction (e.g., both rotated in a clockwise direction). Concurrently, the roller clamps 630 press on the sheet 130, creating tension forces on the sheet 130. The tension forces are sufficient to minimize or eliminate any gaps between the sheet 130 and the workpiece 110. In this example, the sheet feeder 410 (if used to provide the sheet 130) is not required to provide the tension forces.

During the bonding stage, the pulsed laser 150 and the roller clamps 630 may be moved in tandem in the same direction. For example, the bonding direction 501 and clamp displacement direction 601 may be parallel. The bonding direction 501 refers to a direction in which a bond between the sheet 130 and the workpiece 110 develops or grows. In the case where the bonding stage includes laser welding, the bonding direction 501 is essentially also the laser scan direction. For example, the laser scan speed and clamp displacement speed may be the same or substantially the same. As the laser 150 travels into a yet-to-be welded region 233 of the layer 130, the path travelled by the laser 150 becomes part of the welded region 232. The yet-to-be-welded region 233 of the layer 130 is joined to the workpiece 110 (becoming part of the welded region 232) in the opening between the slidable clamps 640.

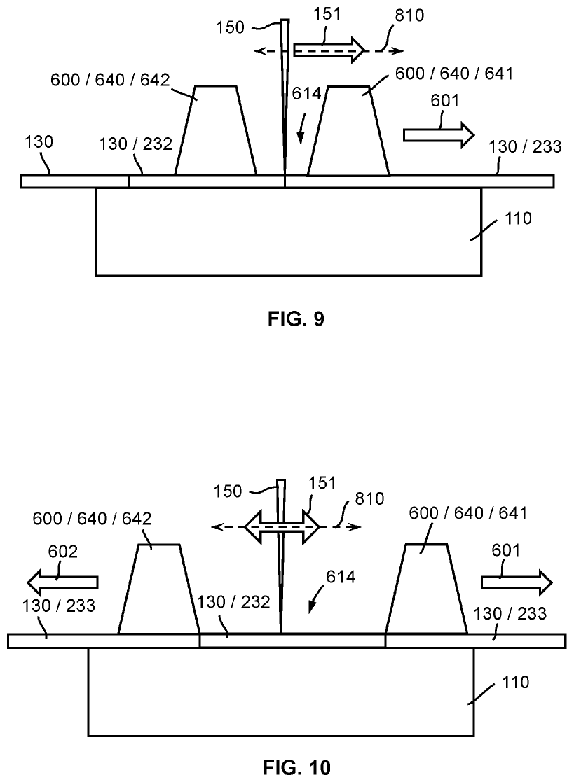

FIG. 9 is a schematic drawing of a part of the apparatus 400 according to yet another embodiment of the present disclosure. In place of the clamping plate 610/620, the clamp 600 includes a set of slidable clamps 640. The pulsed laser 150 is positioned between a first slidable clamp 641 and a second slidable clamp 642. The new sheet 130 is disposed between the workpiece 110 and the slidable clamps 640.

In this example, during the step 203 of laser welding (e.g., FIG. 1C, FIG. 3D, etc.), the first slidable clamp 641 and the second slidable clamp 642 are displaced in the same direction 601 (e.g., both sliding in the same direction along a first axis 810). Concurrently, the slidable clamps 640 press on the sheet 130, creating tension forces on the sheet 130. The tension forces are sufficient to minimize or eliminate any gaps between the sheet 130 and the workpiece 110. In this example, the sheet feeder 410 (if used to transport the sheet 130 into and out of the working zone 440) is not required to provide the tension forces.

The pulsed laser 150 and the slidable clamps 640 are moved concurrently in the same direction 601 (e.g., along first axis 810) at the same speed (laser scan speed 605 and sliding clamp speed 704). As the laser 150 travels into a yet-to-be welded region 233 of the layer 130, the path travelled by the laser 150 becomes part of the welded region 232. The yet-to-be-welded region 233 of the layer 130 is joined to the workpiece 110 (becoming part of the welded region 232) in the opening between the slidable clamps 640.

FIG. 10 is a schematic drawing of a part of the apparatus 400 according to yet another embodiment of the present disclosure. In place of the clamping plate 460, the clamp 600 includes a set of slidable clamps 640. The pulsed laser 150 is positioned between the first slidable clamp 641 and the second slidable clamp 642. The new sheet 130 is disposed between the workpiece 110 and the slidable clamps 710.

In this example, during the step 203 of laser welding (e.g., FIG. 1C, FIG. 3D, etc.), the first slidable clamp 641 and the second slidable clamp 642 are displaced in the opposite directions 601/602 relative to one another (e.g., both sliding in opposite directions parallel to the first axis 810). Concurrently, the slidable clamps 640 press on the sheet 130, creating tension forces on the sheet 130. The tension forces are sufficient to minimize or eliminate any gaps between the sheet 130 and the workpiece 110. In this example, similarly to the examples of FIG. 9, the sheet feeder 410 (if used for dispensing the layer 130) is similarly not required to provide the tension forces to keep the layer 130 flat or substantially flat.

The pulsed laser 150 may scan the area between the two slidable clamps 640. As the area of the welded region increases, the slidable clamps 640 may be displaced further apart from one another, to expose areas in which the layer 130 is yet-to-be welded or yet-to-be-joined to the workpiece 110. The yet-to-be-welded region 233 of the layer 130 is joined to the workpiece 110 in the opening between the slidable clamps 640.

In another example, one of the slidable clamps 640 (e.g., a first slidable clamp 641) may be stationary relative to the pulsed laser 150, and another of the slidable clamps 640 (e.g., a second slidable clamp 642) may be displaced increasingly spaced apart from the stationary slidable clamp 641. The displacement of the second slidable clamp 642 may be parallel to a part of the pulsed laser 150 scanning direction, e.g., parallel to the first axis 810. As the laser 150 travels into a yet-to-be welded region 233 of the layer 130, the path travelled by the laser 150 becomes part of the welded region 232. The yet-to-be-welded region 233 of the layer 130 is joined to the workpiece 110 in the opening between the slidable clamps 640.

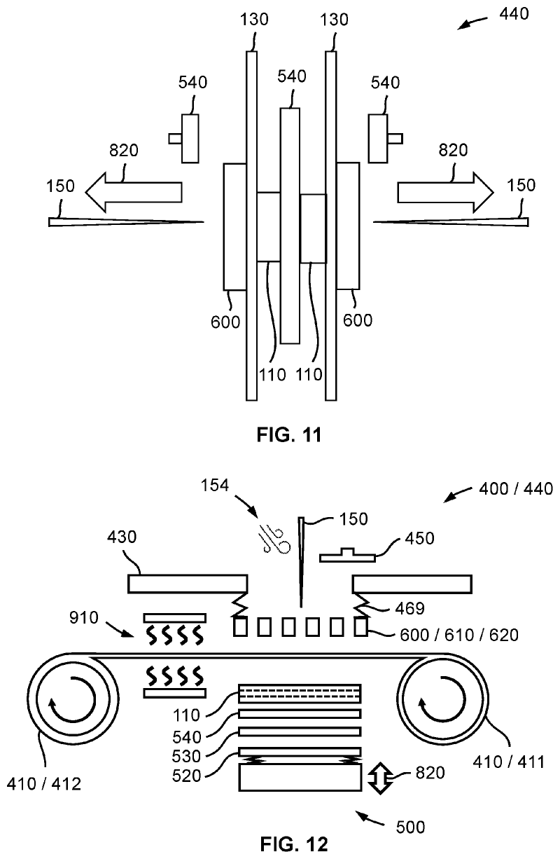

FIG. 11 is a schematic drawing of another embodiment of a part of the apparatus 400. The present method and apparatus is suitable for dual-directional printing, e.g., to increase production efficiency. One or more workpieces 110 may be processed concurrently. The base plate 540 is optional, e.g., when one workpiece 110 is built up simultaneously in different built directions. A sheet 130 is clamped between the workpiece 110 and a displaceable clamp 600. The displaceable clamp 600 may include any one of the following types of clamp parts, e.g., a clamping plate 610/620, rotatable clamp 630, and/or slidable clamp 640. A pulsed laser 150 and a polishing device 540 may be provided at each end of the set-up.

FIG. 12 schematically illustrates a part of the apparatus 400 suitable for use in forming cell arrays and/or complex channels, in which the bonding stage can be based on methods other than laser welding. For example, the apparatus 400 may include a radiator zone 910. The radiator zone 910 may be distinct from the heater/cooler 530. For example, the radiator zone 910 may be disposed proximal to the sheet 130, before the sheet arrives at the working zone 440; the heater/cooler 530 may be disposed proximal to the workpiece.

In use, the radiator 910 may be used to pre-heat the sheet 130 before the sheet 130 is pressed against the workpiece. This embodiment of the apparatus 400 may be used in examples in which the sheet 130 is formed of carbon fiber reinforced composites and/or polymers. The polymers may include but is not limited to thermoplastics such as thermoplastic polyurethane (TPU).

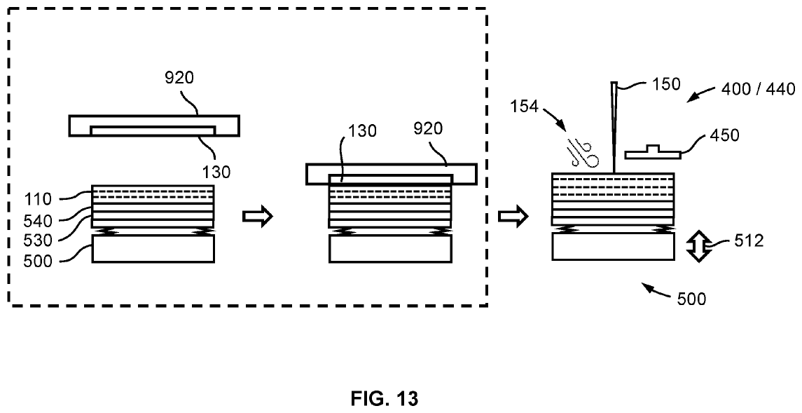

FIG. 13 schematically illustrates another embodiment of the apparatus 400. In this example, the apparatus 400 includes a friction welding tool 920 that also serves as a clamp 600 to hold the sheet 130 in the reference plane 101 in contact with the workpiece 110. In the bonding stage, the sheet 130 is “clamped” or held to the workpiece 110 and bonded to the workpiece 110 by friction welding. Thereafter, the friction welding tool 920 may be removed and the laser 150 may be positioned in the working zone to perform laser cutting and to cut the newly bonded sheet 130 into desired patterns.

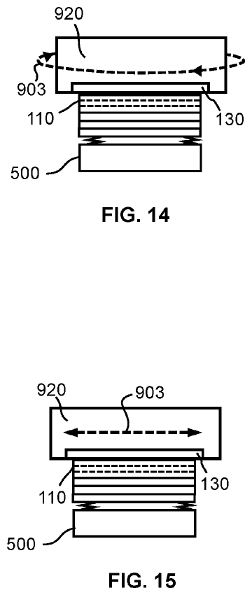

FIG. 14 schematically illustrates one example of friction welding, namely, rotary friction welding or rotational friction welding. FIG. 15 schematically illustrates another example of friction welding, namely, linear frictional welding or translational friction welding. In these examples, the friction welding tool 920 may include a holder or grips to securely hold a discrete piece of the sheet 130. The friction caused by a rubbing action between the sheet 130 and the workpiece 110 generates heat that welds the sheet 130 to the workpiece 110, e.g., relative motion 903 between physically contacting sheet 130 and workpiece 110. In the example of rotary friction welding (FIG. 14), a continuous rotational relative motion 903 may be provided between the sheet 130 and the workpiece 110. In the example of linear friction welding (FIG. 15), an oscillatory sliding relative motion 903 between the sheet 130 and the workpiece 110 may be provided.

In some examples, the apparatus 400 may be configured to provide the relative motion 903 by moving the friction welding tool 920 while holding the workpiece 110 stationary. In some other examples, the apparatus 400 may be configured to provide the relative motion 903 by moving the workpiece 110 while holding the friction welding tool 920 stationary. In yet other examples, both the workpiece 110 and the sheet 130 are in motion, with relative motion 903 therebetween to produce a friction welding effect. The workpiece 110 may be put in motion or held stationary by the workpiece positioner 500.

In some examples, the bonding stage may include applying an adhesive between the sheet 130 and the workpiece 110, and pressing the sheet 130 and the workpiece 110 together. The sheet 130 and the workpiece 110 may be pressed together using any one of the clamps described in the foregoing.

Various embodiments of the apparatus 400 may be used to perform the method disclosed herein to manufacture (e.g., as part of a continuous production line in mass manufacturing) articles formed of multiple materials (multimaterial). The apparatus 400 may include a sheet feeder 410, a workpiece positioner 500, and a clamp 600. The clamp 600 and the workpiece positioner 500 may cooperatively flatten a sheet 130 between the clamp 600 and a workpiece 110. The clamping provided by the clamp 600 and the workpiece 110 helps to apply tensional forces to the sheet 130 and aids in compliance of the sheet 130 against the first surface 111 of the workpiece 110. The clamp 600 may define at least one elongated opening 614 through which a laser 150 may irradiate the sheet 130 along a scan path. The laser 150 is preferably a pulsed laser alternately operable to join the sheet with the workpiece and to cut through the sheet. The method 200 of making the article using the apparatus 400 may include welding a selected area 140 of the sheet 130 of the first material to the workpiece 110; cutting along an outer perimeter 141 of the selected area 140 to form an isolated pattern 135; cutting a sheet of a second material to form a connected pattern 138; mating the connected pattern 138 with the isolated pattern 135; and welding an interface 139 therebetween.

In various embodiments, the clamp 600 may be described as including at least one clamp member (e.g., clamp bar 610/620, rotatable clamp 630, slidable clamp 640, etc.) that is displaceable along the first axis 810. In some embodiments, the at least one clamp member is displaceable by rotation or by sliding. In some embodiments, the clamp 600 includes two clamp members that are apart to define the elongated opening 614, and at least one of the two clamp members is displaceable along a direction of scanning of the laser 150 (e.g., a direction parallel to the reference plane 101). In some embodiments, one of the two clamp members is displaceable away from another of the two clamp members. Preferably, the displacement of the at least one clamp member is along a direction (e.g., parallel to the reference plane 101) conducive to improve compliance (or flattening) of the sheet 130 against the first surface 111 of the workpiece 110.

The above description of various examples of the apparatus 400 is non-exhaustive and merely illustrative. The apparatus 400 includes at least one displaceable clamp 600. The at least one displaceable clamp 600 cooperates with the workpiece 110 (supported by the workpiece positioner 500) such that a flat or substantially flat region of the sheet 130 is presented to the pulsed laser 150. Such an effective and dynamic clamping enables the pulsed laser 150 to scan and join lengths or sections of the layer 130 to the workpiece 110, and not be limited to spot welding. The relatively narrow widths of the openings 614 between parts of the displaceable clamp 600 (in comparison with the dimensions of the working zone 440) limits any warpage of the layer 130 in the working zone 440.

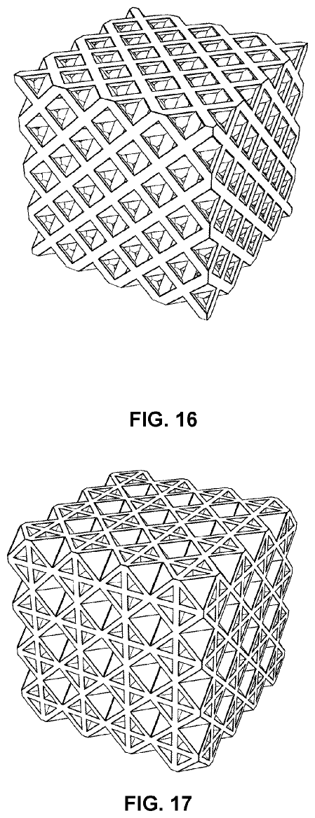

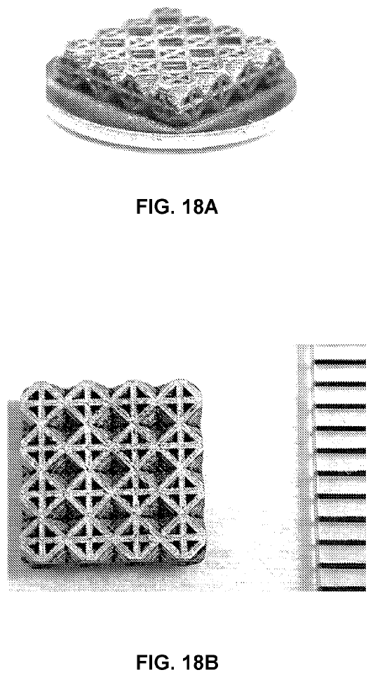

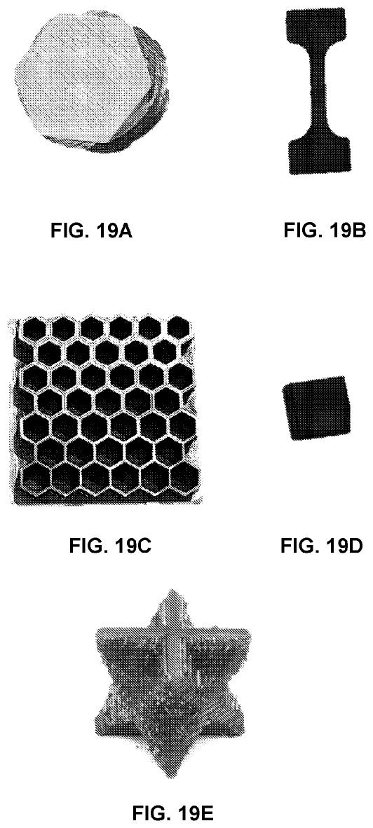

FIG. 16 and FIG. 17 are perspective views of 3D articles that can be made using the present method and apparatus. FIG. 18A and FIG. 18B are images of the 3D array of cells of FIG. 17, produced using the present method and apparatus. Each marking on the ruler in FIG. 18B represents 1 mm. These demonstrated that the present method and apparatus are capable of forming 3D arrays of cells. FIGS. 19A to 19E are images of articles of various materials made using the present method and apparatus. These demonstrated the broad applicability of the present method and apparatus for making articles of different materials. For example, a closed cell of stainless steel 304L (SS304L) was fabricated (FIG. 19A). A specimen of carbon fiber reinforced composite was successfully fabricated (FIG. 19B). A 3D array of a honeycomb structure was made using SS304L (FIG. 19C). An article of ethylene propylene diene monomer (EPDM) was made (FIG. 19D). It was demonstrated that paper and other materials of natural origins could also be used in the present method and apparatus (FIG. 19E).

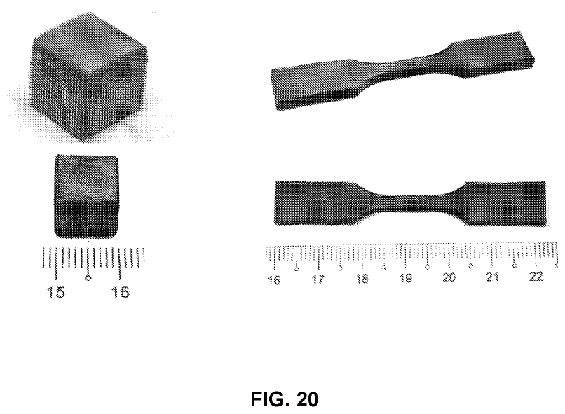

Without being bound by theory, the ability to provide a flat or substantially flat layer 130 can enable pulsed laser scanning or laser joining/welding in lengths or sections (as opposed to spot welding) provides conditions conducive for stronger joining and/or microstructures. FIG. 20 shows images of exemplary specimens made using the present method and apparatus for tensile strength tests. The test results showed that the ultimate tensile strength (UTS) of the specimens fabricated could range from 800 MPa and above. UTS of about 1700 MPa at yield strength of about 980 MPa (0.2% offset yield strength) was achieved experimentally. This is a significant improvement over what could be achieved using conventional methods. For example, laser foil printing reported yield strengths lower than 600 MPa and UTS lower than 1000 MPa.

In one aspect, the present disclosure describes various embodiments of an apparatus. The apparatus includes a laser, a clamp, and a workpiece positioner. The laser is operable as a pulsed laser to cut a sheet. The clamp is displaceable relative to a working zone of the apparatus. The workpiece positioner is configured to support a workpiece in the working zone with the workpiece. In a bonding stage, the clamp and the workpiece positioner are operable to cooperatively push the sheet and the workpiece toward one another, and a selective bonding of the sheet with the workpiece is formed in the bonding stage. In a cutting stage, the clamp is displaceable away relative to the working zone to enable the laser to cut the sheet along a perimeter of the selective bonding.

The apparatus may further include a sheet feeder. The sheet feeder may be operable to feed a sheet along a first axis to dispose the sheet in parallel to a reference plane in the working zone. The workpiece positioner may be displaceable along a second axis to push a first surface of a workpiece against the sheet in the working zone, in which the second axis is normal to the reference plane. The clamp and the workpiece positioner may be configured to cooperatively flatten the sheet between the clamp and the first surface of the workpiece, in which the clamp may define at least one continuous scan path in the reference plane. The laser is configurable to irradiate the sheet along the scan path, in which the laser is a pulsed laser alternately operable to join the sheet with the workpiece and to cut through the sheet.

The laser may be operable to form a first joint between the sheet and the workpiece, in which the first joint comprises at least one continuous welded length parallel to the reference plane.

The sheet feeder may include a first drum roller and a second drum roller, in which the first drum roller and the second drum roller are configured to rotate in a same direction, and in which the sheet is a continuous sheet provided by the second drum roller and collected by the first drum roller.

The workpiece positioner may include a base plate coupled with a compressive force sensor. In response to a feedback from the compressive force sensor, the base plate may be controllably pushed towards the reference plane to cooperatively clamp the workpiece and the sheet together.

The workpiece positioner may include positioning rollers coupled with a shear force sensor. The positioning rollers may be disposed to engage opposing sides of the workpiece. In response to a feedback from the shear force sensor, the positioning rollers may be controllably rotated to displace the workpiece away from the reference plane.

The clamp may include at least one clamp member displaceable along the first axis.

The at least one clamp member may be displaceable by one of rotation and sliding.

The clamp may include two clamp members. The two clamp members may be spaced apart to define the elongated opening. At least one of the two clamp members may be displaceable along a direction of scanning of the laser.

One of the two clamp members may be displaceable away from another of the two clamp members.

The workpiece positioner may be displaceable along a second axis to push a first surface of the workpiece against the sheet, in which the second axis is normal to the reference plane. The clamp and the workpiece positioner may be configured to cooperatively flatten the sheet between the clamp and the first surface of the workpiece. The laser is configurable to cut the sheet along at least one scan path, in which the at least one scan path may be defined by the clamp to be at least one continuous path.

The apparatus may further include a radiator configured to pre-heat the sheet prior to the bonding stage.

The selective bonding may include an adhesive joint.

The clamp and the workpiece positioner may be configured to provide a relative motion between the sheet and the workpiece, in which the selective bonding includes a friction welded joint.

The apparatus may further include a sheet feeder operable to feed the sheet along a feed direction to dispose the sheet in the working zone.

In another aspect, the present disclosure describes various embodiments of a method. The method includes: in a bonding stage, cooperatively pushing a sheet and a first surface of a workpiece together between a clamp and a workpiece positioner simultaneously with a forming of a selective bonding of the sheet with the workpiece; displacing the clamp away relative to the working zone; and in a cutting stage, laser cutting along a perimeter of the selective bonding.

The forming of the selective bonding may include any one of laser welding, pre-heating, friction welding, and adhesive bonding.

The method may further include: disposing the sheet in a reference plane in the working zone; and displacing the workpiece along a second axis to abut the first surface of the workpiece against the sheet in the working zone, the second axis being normal to the reference plane;

The method may further include feeding the sheet along a first axis to dispose the sheet in a working zone, in which the first axis is parallel to the reference plane.

The method may include cooperatively flattening the sheet between the clamp and the first surface of the workpiece.

The may include joining the sheet to the first surface of the workpiece by using a laser to irradiate the sheet along a scan path defined by the clamp, in which the laser is a pulsed laser alternately operable to join the sheet with the workpiece and to cut through the sheet.

The method in which the laser is operable to form a first joint between the sheet and the workpiece, and in which the first joint includes at least one continuous welded length parallel to the reference plane.

The method in which the workpiece may be pushed towards the reference plane to cooperatively clamp the workpiece and the sheet together.

The method in which the workpiece may be controllably displaced along the second axis towards the reference plane in response to a feedback from a compressive force sensor.

The method in which the workpiece is displaceable away from the reference plane by positioning rollers, and in which the positioning rollers may be disposed to engage opposing sides of the workpiece.

The method in which the workpiece is controllably displaced away from the reference plane by rotating the positioning rollers in response to a feedback from a shear force sensor.

The method in which the clamp includes at least one clamp member displaceable along the first axis.

The method in which the at least one clamp member is displaceable by one of rotation and sliding.

The method in which the clamp includes two clamp members, the two clamp members being spaced apart to define the elongated opening, and in which at least one of the two clamp members is displaceable along a direction of scanning of the laser.

The method may further include: welding a selected area of the sheet of the first material to the first surface of the workpiece; and cutting along an outer perimeter of the selected area to form an isolated pattern.

The method may further include: cutting along an inner perimeter of the selected area to form a cavity surrounded by the selected area.

The method may further include: cutting a sheet of a second material to form a connected pattern, the connected pattern including a cavity complementary to the selected area; mating the connected pattern with the isolated pattern; and welding an interface between the first material and the second material, the interface being defined by the outer perimeter of the selected area.

In yet another aspect, the present disclosure describes various embodiments of an article. The article includes an array of cells, each of the cells including at least one cell wall defining an interior space, in which the at least one cell wall includes a plurality of layers joined together using any embodiment of the method described above.

The article in which the at least one cell wall includes a plurality of materials.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the claimed invention.

1. An apparatus comprising:
a laser, the laser being operable as a pulsed laser to cut a sheet;
a clamp, the clamp being displaceable relative to a working zone of the apparatus;
a workpiece positioner, the workpiece positioner being configured to support a workpiece in the working zone with the workpiece,
wherein in a bonding stage, the clamp and the workpiece positioner are operable to cooperatively push the sheet and the workpiece toward one another, a selective bonding of the sheet with the workpiece being formed in the bonding stage,
and wherein in a cutting stage, the clamp is displaceable away relative to the working zone to enable the laser to cut the sheet along a perimeter of the selective bonding.

2. The apparatus as recited in claim 1, the apparatus comprising
a sheet feeder, the sheet feeder being operable to feed a sheet along a first axis to dispose the sheet in parallel to a reference plane in the working zone,
wherein the workpiece positioner is displaceable along a second axis to push a first surface of a workpiece against the sheet in the working zone, the second axis being normal to the reference plane;
wherein the clamp and the workpiece positioner are configured to cooperatively flatten the sheet between the clamp and the first surface of the workpiece, the clamp defining at least one continuous scan path in the reference plane, and
wherein the laser is configurable to irradiate the sheet along the scan path, wherein the laser is as a pulsed laser alternately operable to join the sheet with the workpiece and to cut through the sheet.

3. The apparatus as recited in claim 2, wherein the laser is operable to form a first joint between the sheet and the workpiece, and wherein the first joint comprises at least one continuous welded length parallel to the reference plane.

4. The apparatus as recited in claim 2, wherein the sheet feeder comprises a first drum roller and a second drum roller, the first drum roller and the second drum roller being configured to rotate in a same direction, and wherein the sheet is a continuous sheet provided by the second drum roller and collected by the first drum roller.

5. The apparatus as recited in claim 2, wherein the workpiece positioner comprises a base plate coupled with a compressive force sensor, and wherein, in response to a feedback from the compressive force sensor, the base plate is controllably pushed towards the reference plane to cooperatively clamp the workpiece and the sheet together.

6. The apparatus as recited in claim 5, wherein the workpiece positioner comprises positioning rollers coupled with a shear force sensor, the positioning rollers being disposed to engage opposing sides of the workpiece, and wherein, in response to a feedback from the shear force sensor, the positioning rollers are controllably rotated to displace the workpiece away from the reference plane.

7. (canceled)

8. The apparatus as recited in claim 1, wherein the clamp is configured to be displaceable during the bonding stage.

9. The apparatus as recited in claim 2, wherein the clamp comprises two clamp members, the two clamp members being spaced apart to define the elongated opening, and wherein at least one of the two clamp members is displaceable along a direction of scanning of the laser, at least one of the two clamp members being displaceable along the first axis, and wherein one of the two clamp members is displaceable away from another of the two clamp members.

10. (canceled)

11. The apparatus as recited in claim 1,
wherein the workpiece positioner is displaceable along a second axis to push a first surface of the workpiece against the sheet, the second axis being normal to the reference plane;
wherein the clamp and the workpiece positioner are configured to cooperatively flatten the sheet between the clamp and the first surface of the workpiece, and
wherein the laser is configurable to cut the sheet along at least one scan path, the at least one scan path being defined by the clamp to be at least one continuous path.

12. The apparatus as recited in claim 1, further comprising a radiator configured to pre-heat the sheet prior to the bonding stage.

13. (canceled)

14. The apparatus as recited in claim 1,
wherein the clamp and the workpiece positioner are configured to provide a relative motion between the sheet and the workpiece,
and wherein the selective bonding includes one of a friction welded joint and an adhesive joint.

15. The apparatus as recited in claim 11, further comprising:
a sheet feeder, the sheet feeder being operable to feed the sheet along a feed direction to dispose the sheet in the working zone.

16. A method comprising:
in a bonding stage, cooperatively pushing a sheet and a first surface of a workpiece together between a clamp and a workpiece positioner simultaneously with a forming of a selective bonding of the sheet with the workpiece;
displacing the clamp away relative to the working zone; and
in a cutting stage, laser cutting along a perimeter of the selective bonding.

17. (canceled)

18. The method as recited in claim 16, further comprising:
disposing the sheet in a reference plane in the working zone; and
displacing the workpiece along a second axis to abut the first surface of the workpiece against the sheet in the working zone, the second axis being normal to the reference plane;
feeding the sheet along a first axis to dispose the sheet in a working zone, wherein the first axis is parallel to the reference plane; and
cooperatively flattening the sheet between the clamp and the first surface of the workpiece.

19. (canceled)

20. (canceled)

21. The method as recited in claim 16, the method comprising:
joining the sheet to the first surface of the workpiece by using a laser to irradiate the sheet along a scan path defined by the clamp, wherein the laser is a pulsed laser alternately operable to join the sheet with the workpiece and to cut through the sheet:
and wherein the laser is operable to form a first joint between the sheet and the workpiece, and wherein the first joint comprises at least one continuous welded length parallel to the reference plane;
and wherein the workpiece is pushed towards the reference plane to cooperatively clamp the workpiece and the sheet together.

22. (canceled)

23. (canceled)

24. The method as recited in claim 21, wherein the workpiece is controllably displaced along a second axis towards the reference plane in response to a feedback from a compressive force sensor.

25. The method as recited in claim 21, wherein the workpiece is displaceable away from the reference plane by positioning rollers, and wherein the positioning rollers are disposed to engage opposing sides of the workpiece.

26. The method as recited in claim 25, wherein workpiece is controllably displaced away from the reference plane by rotating the positioning rollers in response to a feedback from a shear force sensor.

27. (canceled)

28. (canceled)

29. (canceled)

30. The method as recited in claim 21, further comprising:
welding a selected area of the sheet of a first material to the first surface of the workpiece;
cutting along an outer perimeter of the selected area to form an isolated pattern;
cutting a sheet of a second material to form a connected pattern, the connected pattern including a cavity complementary to the selected area;
mating the connected pattern with the isolated pattern; and
welding an interface between the first material and the second material, the interface being defined by the outer perimeter of the selected area.

31. (canceled)

32. (canceled)

33. An article comprising: an array of cells, each of the cells including at least one cell wall defining an interior space, wherein the at least one cell wall includes a plurality of layers joined together during the bonding stage using the method as recited in claim 16, wherein the at least one cell wall comprises a plurality of materials.

34. (canceled)
